(19) United States
(12) Patent Application Publication
(10) Pub. No.: US 2009/0320979 A1
(43) Pub. Date: Dec. 31, 2009

(54) Hearing Aid Microphone Cover

(75) Inventors: Lloyd G. Keleny, Champlin, MN (US); Shu Lam Sin, Hong Kong (CN)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: DONALDSON COMPANY, INC., Minneapolis, MN (US)

(21) Appl. No.: 12/293,182

(22) PCT Filed: Mar. 16, 2007
(86) PCT No.: PCT/US07/64122

§ 371 Date: Jan. 12, 2009

Related U.S. Application Data
(60) Provisional application No. 60/743,537, filed on Mar. 17, 2006.

(51) Int. Cl. B65D 65/02; B29C 45/00

(52) U.S. Cl. 150/154; 264/328.1

(57) ABSTRACT

The present invention relates to hearing aid microphone covers and methods of manufacturing the same. In an embodiment, the invention includes a microphone cover for a hearing aid including a frame defining one or more exterior apertures and one or more media apertures, and a filtration media attached to the frame, the filtration media configured to completely occlude the one or more exterior apertures. In an embodiment, the invention includes a method of forming a microphone cover for a hearing aid including placing oleophobic and hydrophobic filtration media within a mold and forming a polymeric frame around the filtration media by injecting a polymer composition into the mold.

### FIELD OF THE INVENTION

The present invention relates to covers to keep contaminants out of hearing aids and methods of manufacturing the same. More specifically, the present invention relates to hearing aid microphone covers and methods of manufacturing the same.

### BACKGROUND OF THE INVENTION

Hearing aids typically contain a microphone to collect ambient sound which is then amplified and transmitted to the wearer's ear. Many hearing aids, such as behind-the-ear (BTE) designs, have a small case that fits behind the ear and conduct sound through an ear mold that is custom made to fit the wearer's ear. Generally, ambient sound reaches the microphone through an aperture (microphone aperture) in the case.

BTE hearing aids can be used for mild to profound hearing losses and are especially useful for children because of their durability. However, because BTE hearing aids are worn on the body, they are exposed to the environment including contaminants such as dirt, dust, hairspray, water, etc. These contaminants can enter the hearing aid through the microphone aperture and degrade the functioning of the hearing aid and/or shorten its service life.

Therefore, a need exists for devices to prevent or reduce exposure of the hearing aid components to contaminants and methods for manufacturing the same.

### SUMMARY OF THE INVENTION

The present invention relates to hearing aid microphone covers and methods of manufacturing the same. In an embodiment, the invention includes a microphone cover for a hearing aid including a frame defining one or more exterior apertures and one or more media apertures, and filtration media attached to the frame, the filtration media configured to completely occlude the one or more exterior apertures. In an embodiment, the invention includes a method of forming a microphone cover for a hearing aid including placing oleophobic and hydrophobic filtration media within a mold and forming a polymeric frame around the filtration media by injecting a polymer composition into the mold.

The above summary of the present invention is not intended to describe each discussed embodiment of the present invention. This is the purpose of the figures and the detailed description that follows.

### DRAWINGS

The invention may be more completely understood in connection with the following drawings, in which:

FIG. 1 is top view of a microphone cover in accordance with an embodiment of the invention.

FIG. 2 is a side view of the microphone cover of FIG. 1.

FIG. 3 is a cross-sectional view of a microphone cover taken along line A-A′ of FIG. 2.

FIG. 4 is a top view of a microphone cover in accordance with another embodiment of the invention.

FIG. 5 is a cross-sectional view of the microphone cover of FIG. 4, taken along line B-B′ of FIG. 4.

FIG. 6 is bottom view of the microphone cover of FIG. 4.

FIG. 7 is top view of a microphone cover in accordance with another embodiment of the invention.

FIG. 8 is a cross-sectional view of the microphone cover of FIG. 7, taken along line C-C′ of FIG. 7.

FIG. 9 is a bottom view of the microphone cover of FIG. 7.

FIG. 10 is a side view of the microphone cover of FIG. 7.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

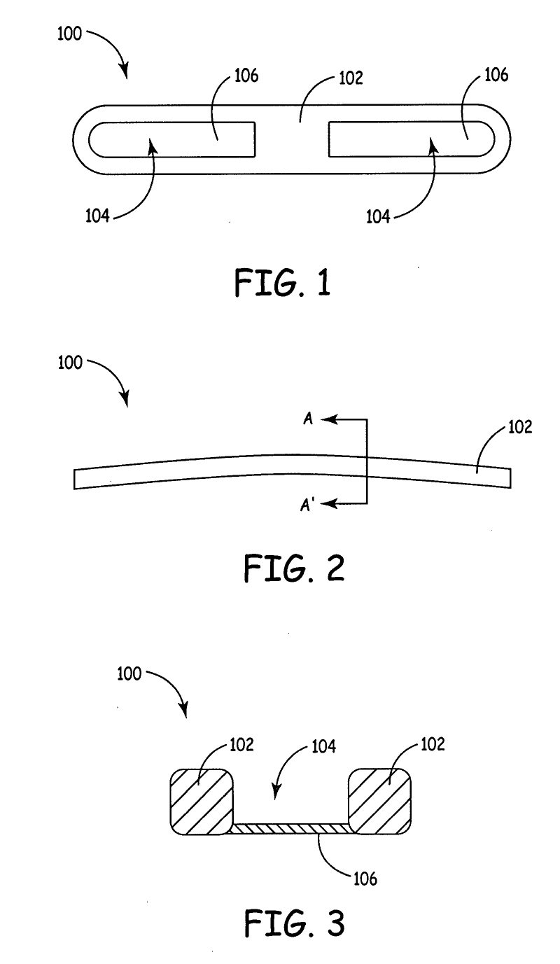

Embodiments of the current invention include covers for hearing aid microphones that can prevent or reduce exposure of the hearing aid components to contaminants and methods for manufacturing the same. Specifically, hearing aid microphone covers as described herein can cover the microphone aperture on hearing aids, such as behind-the-ear hearing aids, and therefore prevent or reduce ingress of contaminants. In some embodiments, the hearing aid microphone cover includes filter media that is oleophobic and hydrophobic, enhancing the ability of the cover to prevent or reduce ingress of contaminants into the hearing aid. Referring to FIG. 1, a top schematic view of a microphone cover 100 in accordance with an embodiment of the invention is shown. The microphone cover 100 includes a frame 102 that defines two exterior apertures 104, 104. Embodiments of the invention can include one or more exterior apertures 104 in the frame 102. Filtration media 106 is disposed so as to occlude the exterior apertures 104 of the frame 102. In some embodiments, the filtration media 106 is disposed within the exterior apertures 104 of the frame 102.

The filtration media 106 can prevent the passage of contaminants such as dirt, dust, oil, water, etc. through the exterior apertures 104 in the frame 102. However, the filtration media 106 allows pressure waves (sound) to pass through the exterior apertures 104 with no significant loss of sound quality.

If the filtration media 106 is not sufficiently thick, it may not provide an adequate barrier against the ingress of contaminants. In an embodiment, the filtration media 106 is at least about 0.0005 inches thick. If the filtration media 106 is too thick, it may unduly interfere with the transmission of ambient sound to the microphone. In an embodiment, the filtration media is less than about 0.125 inches thick. In some embodiments, the filtration media is about 0.0005 inches to about 0.125 inches thick. In a particular embodiment, the filtration media is about 0.008 inches thick. It is believed that the permeability of the filtration media can affect transmission of ambient sound to the microphone. In an exemplary embodiment, the air permeability of the material used to make the filtration media is about 163 cfm/ft² according to ASTM D737-75.

The filtration media 106 can include a woven or a non-woven porous material. In some embodiments, the filtration media 106 includes a fibrous woven or non-woven material. An exemplary material is a high strength nylon non-woven spunbond material sold under the trade name CEREX®, commercially available from Western Nonwovens, Inc., Carson, Calif.

The filtration media 106 can optionally be treated to provide various properties. For example, a fluorochemical may be used to impart hydrophobic and/or oleophobic properties onto the filtration media 106. An exemplary fluorochemical is RAINOFF® SBF and is commercially available from Eastern Color and Chemical Company, Providence, R.I. However, it will be appreciated that many other fluorochemicals are available that can be used to provide hydrophobic and/or oleophobic properties. Fluorochemicals having hydrophobic and oleophobic are disclosed in U.S. Pat. No. 5,354,598, the contents of which is herein incorporated by reference.

FIG. 2 is a side schematic view of the microphone cover of FIG. 1. In this view it can be seen that the frame 102 is curved. However, in other embodiments, the frame 102 is flat. Depending on the configuration of the hearing aid case, curvature of the frame can enhance the fit between the frame 102 and the aperture in the hearing aid case that leads to the microphone.

FIG. 3 is a cross-sectional view of a microphone cover taken along line A-A′ of FIG. 2. The frame 102 defines the exterior aperture 104 while the filtration media 106 covers the exterior aperture 104. The frame 102 can be made of many different materials. By way of example, the frame 102 can be made of a polymeric material, a metal, a composite, and the like. The frame 102 can include polymers such as polyethylene, polypropylene, polystyrene, polyethylene terephthalate, polyamide, polyester, polyvinyl chloride, polycarbonate, acrylonitrile butadiene styrene, polytetrafluoroethylene, polyurethane, and the like.

In some embodiments, the filtration media 106 is disposed so that turbulent flow of air over the exterior aperture 104 is minimized. The turbulent flow of air can create noise which may be picked up by the microphone and be audible to the wearer of the hearing aid. By way of example, the filtration media 106 may be disposed sufficiently close to the top surface of the frame 102 so that air flowing over the frame 102 does not become turbulent or as turbulent.

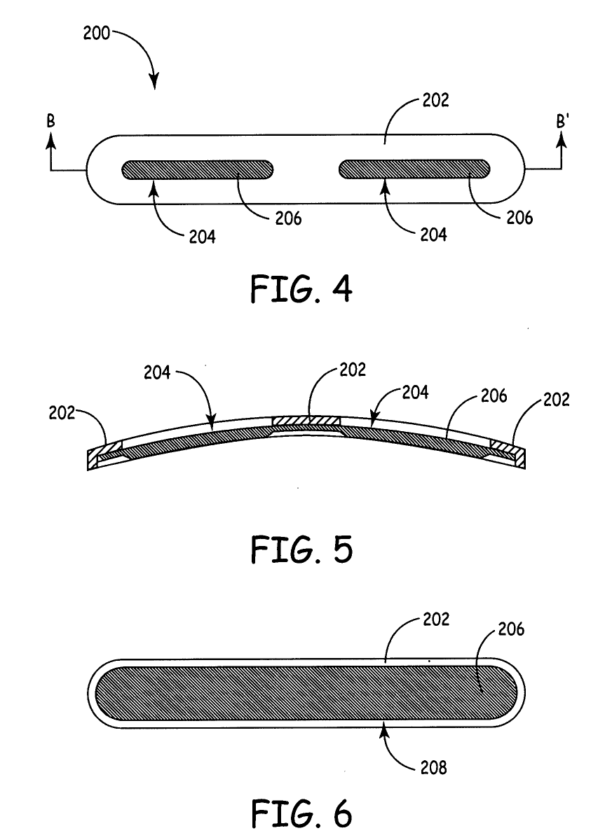

Referring now to FIG. 4, a top schematic view of a microphone cover 200 in accordance with an embodiment of the invention is shown. The microphone cover 200 includes a frame 202 that defines two exterior apertures 204, 204. The exterior apertures 204 have an elongated oval shape. In this specific example, the major axis of the exterior apertures 204 is about eight times longer than the minor axis of the exterior apertures 204. However, the exterior apertures 204 can take on various shapes and configurations. Embodiments of the invention can include one or more exterior apertures 204 in the frame 202. Filtration media 206 is disposed so as to occlude the exterior apertures 204 of the frame 202.

FIG. 5 is a cross-sectional view of the microphone cover of FIG. 4, taken along line B-B′ of FIG. 4. The filtration media 206 is disposed under the exterior apertures 204. However, in some embodiments, the filtration media 206 is disposed within the exterior apertures 204 of the frame 202.

FIG. 6 is bottom schematic view of the microphone cover of FIG. 4. The frame 202 defines a media aperture 208 into which the filtration media 206 fits. The media aperture 208 is larger than the exterior apertures 204. The filtration media 206 may be attached to the frame 202 using various techniques including adhesives, ultrasonic welding, heat welding, compression fitting, etc.

In some embodiments, the frame 202 is molded around the filtration media 206 using a technique that can be referred to as “insert molding” or “over-molding”. In this approach to forming the microphone cover 200, the filtration media 206 is positioned within a mold (not shown) and then the material used to form the frame 202, such as a polymer composition, is injected into the mold. After the polymer composition sets or cures, the mold can then be opened to release the finished microphone cover 200. Insert molding can offer advantages such as secure retention of the filtration media 206 within the frame 202 in the finished microphone cover 200, a more aesthetic appearance of the frame 202 around the filtration media 206, and increased ease of manufacturing.

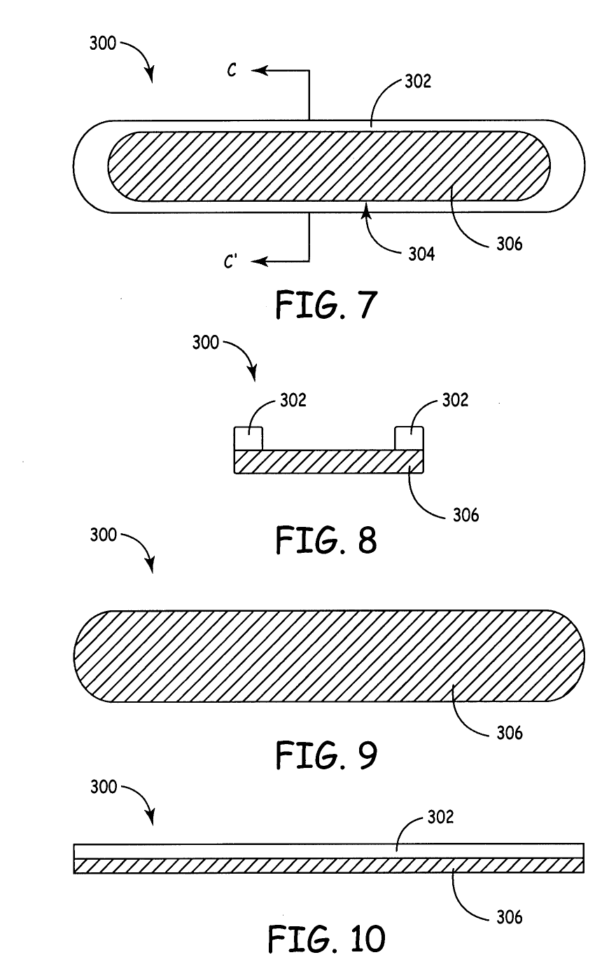

FIG. 7 is top view of a microphone cover 300 in accordance with another embodiment of the invention. The microphone cover 300 includes a frame 302 that defines an exterior aperture 304. Filtration media 306 is disposed so as to occlude the exterior aperture 304 of the frame 302. FIG. 8 is a cross-sectional view of the microphone cover 300 of FIG. 7, taken along line C-C′ of FIG. 7. The frame 302 is attached to the filtration media 306. FIG. 9 is a bottom view of the microphone cover of FIG. 7. In this embodiment, the filtration media 306 covers the entire bottom of the frame 302. FIG. 10 is a side view of the microphone cover of FIG. 7. In this embodiment, the microphone cover 300 is substantially flat along the length of its major axis and not curved.

In an embodiment, the present invention includes a hearing aid (not shown) having a microphone cover as described herein.

It will be appreciated that, although the implementation of the invention described above is directed to behind-the-ear (BTE) hearing aids, the present device may be used with other types of hearing aids, such as in-the-ear (ITE) hearing aids. In addition, while the present invention has been described with reference to several particular implementations, those skilled in the art will recognize that many changes may be made hereto without departing from the spirit and scope of the present invention.

1. A microphone cover for a hearing aid comprising:
a frame defining two or more exterior apertures and one media aperture, wherein the media aperture is larger than each of the two or more exterior apertures, the frame having a top side and a bottom side, the top of the frame defining the two exterior apertures, the bottom of the frame defining the media aperture and wherein the frame comprises a polymer selected from the group of polyethylene polypropylene and acrylonitrile butadiene styrene; and
a woven filtration media attached to the frame and disposed within the one media aperture, the filtration media configured to completely occlude the two or more exterior apertures and be positioned below the exterior apertures, the filtration media comprising an oleophobic and hydrophobic surface.

2. The microphone cover of claim 1, the exterior apertures comprising an oval shape.

3-6. (canceled)

7. The microphone cover of claim 1, the filtration media comprising polyamide.

8. (canceled)

9. The microphone cover of claim 1, the filtration media comprising a fluorochemical.

10. The microphone cover of claim 1, the filtration media having a thickness of about 0.0005 inches to about 0.125 inches.

11. The microphone cover of claim 1, the microphone cover comprising a length and a width, the microphone cover being curved along its length.

12. A method of forming a microphone cover for a hearing aid comprising:
placing oleophobic and hydrophobic woven filtration media within a mold; and
forming a polymeric frame around the filtration media by injecting a polymer composition into the mold; the polymeric frame defining two or more exterior apertures and one media aperture; the oleophobic and hydrophobic filtration media occluding the two or more exterior apertures, wherein the media aperture is larger than each of the two or more exterior apertures, the frame having a top side and a bottom side, the top of the frame defining the two exterior apertures, the bottom of the frame defining the media aperture and wherein the polymer composition comprises a polymer selected from the group of polyethylene, polypropylene and acrylonitrile butadiene styrene.

13. The method of claim 12, further comprising curing the polymeric frame.

14. The method of claim 12, further comprising removing the polymeric frame from the mold.

15. The method of claim 12, the exterior apertures comprising an oval shape.

17. The method of claim 12, the filtration media comprising polyamide.

16. The method of claim 12, the filtration media comprising a fluorochemical.

17. The method of claim 12, the filtration media having a thickness of about 0.0005 inches to about 0.125 inches.

18. The method of claim 12, the microphone cover comprising a length and a width, the microphone cover being curved along its length.

19. The method of claim 12 wherein the media aperture comprising an oval shape.

20. The method of claim 12, wherein the exterior apertures have an elongated oval shape, where the major axis of the exterior apertures is about eight times loner than the minor axis of the exterior apertures.

21. The method of claim 12, wherein the polymeric frame is formed to be contacting the filtration media along the perimeter edge of the filtration media and across a mid-section of the filtration media.

22. The microphone cover of claim 1 wherein the media aperture comprising an oval shape.

23. The microphone cover of claim 1, wherein the exterior apertures have an elongated oval shape, where the major axis of the exterior apertures is about eight times longer than the minor axis of the exterior apertures.

24. The microphone cover of claim 1, wherein the filtration media is connected to the frame along the perimeter and across a mid-section of the filtration media.
